(19) United States
(12) Patent Application Publication
(10) Pub. No.: US 2010/0211425 A1
(43) Pub. Date: Aug. 19, 2010

(54) Arranging on a communications network meetings between persons where the instant estimated time of arrival at a meeting of each prospective attendee is calculated and displayed to the subject attendee, and to all prospective attendees

(76) Inventor: Gunasekaran Govindarajan, San Diego, CA (US)

Correspondence Address: Willliam C. Fuess, 10951 Sorrento Valley Road 2G, San Diego, CA, 92121-1613, US

(21) Appl. No.: 12/660,076

(22) Filed: Feb. 18, 2010

Related U.S. Application Data
(60) Provisional application No. 61/207,923, filed on Feb. 18, 2009.

(51) Int. Cl. G06Q 10/00; G01C 21/34; G01C 21/00; G06F 15/16

(52) U.S. Cl. 705/8; 701/204; 701/213; 701/300; 709/205

(57) ABSTRACT

In a method performed on and between communicating devices distributed upon a communications network for the purpose(s) of soliciting and arranging and initiating a meeting, the communication device of each prospective attendee of a meeting supplies its instant geographical location to a central computer. The central computer calculates from the received instant geographical locations, and preferably also any of weather, traffic flow rate, traffic roadblocks and stoppages, the traffic route being followed to the meeting location, and the actual rate of progress along the route to the meeting location—the estimated time of arrival of each prospective attendee at the meeting. This ETA for each prospective meeting attendee is sent from the central computer to the communications devices of all prospective attendees, permitting each and all to see their own progress or lack thereof, and also that of others, to the meeting. The instant geographical locations of all prospective attendees supplied to the central computer are likewise preferably distributed by the central computer to all prospective attendees, and graphically displayed in real time.

### REFERENCE TO RELATED PATENT APPLICATIONS

The present application is related to, and claims benefit of priority of, U.S. Provisional Patent applications Ser. No. 61/207,923 filed Feb. 18, 2009, for “Controlled Location Sharing in a Mobile Environment” in the name of the selfsame inventor of the present application.

The present application is related to U.S. patent application Ser. No. 11/AAA,AAA for ARRANGING ON A COMMUNICATIONS NETWORK MEETINGS BETWEEN PERSONS WHERE THE INSTANT GEOGRAPHICAL LOCATION OF EACH PROSPECTIVE ATTENDEE IS GRAPHICALLY DISPLAYED TO ALL PROSPECTIVE ATTENDEES and U.S. patent application Ser. No. 11/BBB,BBB for ARRANGING MEETINGS ON A COMMUNICATIONS NETWORK WITH NECESSARY COORDINATING COMMUNICATIONS CONSERVED BY (1) REMOTENESS TO THE SCHEDULED TIME OF MEETING, AND/OR ANY ATTENDEE'S (2) DISAVOWAL OF, AND/OR (3) FRUSTRATION IN, ACTUALLY ATTENDING THE MEETING, both to the selfsame inventor as is the present application. The contents of the predecessor, and related, patent applications are incorporated herein by reference.

### BACKGROUND OF THE INVENTION

1. Field of the Invention

The present invention relates to solicitation, arranging and starting of meetings between persons having distributed programmable communication devices by communications between these devices transpiring upon a communications network.

The present invention particularly relates to a machine methods facilitating and partially automating the soliciting, arranging and starting of meetings upon a mobile cellular telephony network by software processes running in programmable cellular telephones.

2. Background of the Invention

Despite the increase in virtual meetings, the scheduling, soliciting attendance at, arranging and starting of meetings between real persons in the real world remains essential in both the personal lives and business environments of humans. To schedule, solicit attendance at, arrange and start meeting efficiently and effectively may be as important for effective time management as the conduct of the meetings themselves. Whether it is a casual meeting at a local pub between couple of friends or a project planning meeting with several business associates, the “meeting time” and “meeting venue” are two important factors related to the effective and efficient arranging of meetings.

People presently, circa 2010, schedule meetings using various methods including, simple verbal communication to more sophisticated tools like Microsoft Outlook, Google Calendar, Yahoo Calendar and other Event Management Tools. Some of these tools also provide a reminder feature. Email notifications and audio alerts are used as reminders in many of these tools. These reminders alert the meeting attendees about the forth coming scheduled meetings with respect to scheduled meeting time

All these notifications and alerts are generated without any knowledge about the current status of the meeting participants. This includes the physical location of the participants, travel mode, traffic conditions and weather conditions, for example. Devices with capabilities to acquire location, date & time information could provide important state information, the current Location of the meeting participants. Devices connected to the network could get meeting participants travel modes, weather conditions and real time traffic conditions. Such devices include but not limited to the participant's laptop, a cell phone, cell towers, a personal digital assistant (PDA), a networked computer and any electronic device with a micro-controller.

A network is formed by connecting a plurality of computational devices. Examples of a computational device include, but are not limited to, a personal computer, a laptop, a personal digital assistant (PDA), a mobile phone and any electronic device with a micro-controller. A computational device stores data on a storage device. Examples of a storage device include, but are not limited to, a hard disk, a compact disk, a pen drive, a floppy disk, and a magnetic tape. With technological development computational devices have become capable of accessing data from different geographical locations.

Examples of a network include, but are not limited to, the Internet, an Extranet, an Ethernet, a Local Area Network (LAN), a Personal Area Network (PAN), a Wide Area Network (WAN), a Campus Area Network (CAN), a Metropolitan Area Network (MAN), a Global System Mobile (GSM) network, and a Code Division Multiple Access (CDMA) network.

With the advanced technologies and distributed work locations the number of mobile workers and mobile offices are increasing exponentially. The popularity of social networks and the powerful business ready smart phones increased the number of outside-office meetings. It becomes even more important to know the current status of the meeting participants to effectively manage ones time and resources in the fast mobile working environment.

One or more methods in the market attempt to share location information among the members of the social networks. They either collect users' locations continuously or by sending requests to mobile devices to manually update location data. The later approach adds lots of overhead to the mobile user as they need to constantly respond to these requests.

All these methods collect location information constantly at frequent time intervals to provide the location service. This not only generate lots traffic and consume wireless bandwidth, it consumes substantial battery power from the mobile devices which is very critical for the operation of the mobile devices. More over the mobile user has no clue on who among their network will have access to their location information. The best they can do is to turn-off sending location data or blocking their own contacts from seeing locations. The second approach adds lots of work to the user to turn on/off sharing location information manually.

None of these methods gives little clue to the users why someone have access to their location information, when someone will have access to their location and how much of their location information is shared with others.

There exists a requirement for a system to organize and manage meeting schedules not only with respect to meeting time, but also with respect to meeting location and the current location of the meeting participants.

There exists a requirement for a system to alert not only on time conflict, but also on location conflicts.

There exists a requirement for a system to show the current locations of selective devices or persons only for a predefined period of time.

There exists a requirement for a system to share location information only among scheduled meeting attendees.

There exists a requirement for a system to automatically manage different levels of shared location information among selective group.

There exists a requirement for a system to share location information at different time periods within a selective group of people.

There exists a requirement for a system to automatically provide routing instructions to reach a scheduled meeting location dynamically.

There exists a requirement for a system to suggest alternative meeting locations based on multiple mobile devices and their travel time.

There exists a requirement for a system to take into effect the environmental changes that could affect participants reaching a scheduled meeting place on time and alert the participants.

There exists a requirement for a system take in to consideration the various travel modes used by the participants to reach the scheduled meeting location.

There exists a requirement for a system that can connect all or selective meeting participants with information about each other's current locations for better coordination.

There exists a requirement for a system to show current locations of meeting participants in a geographical map.

There exists a requirement for a system to show the expected arrival time of meeting participants.

There exists a requirement for a system to show meeting venues on a geographical location.

There exists a requirement for a system to allow instant message communications and conference facility among meeting attendees.

Therefore, there exists a need for a method and system to control shared location information. Further, there is a need for a method and system to provide a visual status of meeting attendees on mobile devices. There also exists a need for a method and system to share location data only on need-to-know basis.

There exists a need for a method and system to alert meeting attendees based on current locations in addition to time. Also there exists a need for a method and system to instantly connect relevant parties through Instant Messaging and Conferencing.

### SUMMARY OF THE INVENTION

The present invention contemplates a machine method—implemented in software running in distributed devices communicating upon a communications network—for soliciting, arranging and initiating meetings where any attendee may see an updated display of the then estimated time of arrival (“ETA”) of each and all prospective attendees of the meeting.

Moreover, the frequency of the update of this ETA, and potentially also its scale metric, is changed as the start time of the meeting draws nigh: the ETA's of prospective attendees being more often updated as the time of the meeting draws closer, while the temporal scale of the separation of each prospective attendee from the meeting location normally collapses from hours to minutes and even to seconds as prospective attendees converge upon the meeting site.

### 1. Relationship of the Several Inventions of the Present and Related Patent Applications

For example, machine processes automatically use calendaring systems within each cell phone to respond to requests/proposals generated by anyone to meet at any time and place; first optionally participating in voting on said proposed meeting time and place, and then, ultimately receiving the consensus scheduled time and place, either confirming or disavowing prospective attendance at the meeting. Although the method(s) of the present invention is (are) sophisticated, and useful, even to this point progressed, the real power of the present and related inventions arguably occurs as the prospective attendees to meeting are marshaled to attend, with their individual progress being each of monitored, aided, and displayed.

In the invention of the instant application the location of the communication device of each prospective meeting attendee is monitored, and is so monitored at an increasing rate as the time of the meeting draws nigh. The instant geographical location of each attendee is visually graphically displayed to all, with laggards and/or persons who cannot reasonably reach the start of the meeting and/or registrants not in attendance readily identifiable.

In the invention of a first related application the expected time of arrival (“ETA”) of each prospective attendee at a scheduled meeting is calculated and re-calculated at intervals dependent upon the progress or non-progress of the prospective attendee to the meeting, and the magnitude of any deficit or increase in the deficit of such progress/non-progress. This ETA is calculated based on at least, the instant geographical location of the communication device or cell phone, the location of the meeting, and the time remaining before the start of the meeting.

In accordance with the present invention this ETA for each prospective meeting attendee preferably also based on one or more of the factors of (1) the route of the attendee to the meeting, (2) weather, (3) traffic flow rate, (4) traffic roadblocks and stoppages; and (a) actual rate of progress of the prospective attendee along his/her actual route to the meeting location. The calculated ETAs of all prospective attendees are—at least until timely attendance becomes an impossibility—displayed to all who care to view. The general progress, or lack thereof, of any individual attendee communicating devices/cell phones upon a communications network communicating devices/cell phones upon a communications network, is alerted to that attendee, including by real time message notification to the prospective attendee that he/she must depart for the meeting or risk tardiness. The general progress, or lack thereof, of all attendees collectively may readily be assessed, permitting such basic decisions as to commence the meeting, commence the meeting after a necessary postponement, or cancel the meeting altogether to be intelligently made on best current information.

In the invention of a second related application the potentially sophisticated, and extensive, communications traffic attendant use of communicating devices/cell phones upon a communications network to solicit, arrange and start meetings is conserved. This conservation saves both the battery power of the communicating devices/cell phones, and traffic upon the communications network. Many strategies are used. Devices that at any time opt out from meeting attendance or, separately, do not desire to be kept informed of the status and progress of others to the meeting, receive no message traffic that they do not want, nor need. Devices making satisfactory progress to the meeting are minimally interrogated, while problem areas receive more frequent communications and updates.

In summary, the inventions of the several patent applications act in concert to provide a very powerful, and sophisticated, real time system for the arranging of real-world meetings between humans who are each possessed of, and communicatively connected by, powerful programmable communications devices such as 4G cellular telephones. Although diverse information is preferably presented in graphical form, the present and related inventions do not preclude displaying the same information in a non-graphical form, for example in plain text form, to non-graphics-capable mobile devices, and/or in order to save wireless bandwidth

### 2. Objects of the Present and Related Inventions

One object of the present invention is to generate meeting reminders based on current location, environmental changes like traffic, weather and delay in transportation.

Yet another object of the present invention is to provide a simplified method to select relevant meeting attendees to communicate over Instant Messaging, Voice and/or Video Conferencing.

Yet another object of the present invention is to provide alternative meeting locations based on current estimated travel time.

In accordance with the above-mentioned objects, and those mentioned below, the present invention comprises a method for sharing location data, for a defined time period among selected people. The present invention comprises a method of effectively integrating Calendaring systems, Mobile platforms, Location information, Social and Business networks to have a controlled location sharing. The method collects location data from mobile users and shares various levels of location details between selected people. The location data can only be accessed for a defined time period.

In accordance with the above-mentioned objects, and those mentioned below, the present invention comprises a method for scheduling meetings using popular calendaring systems or proprietary systems. The default visibility time window to share participant's locations among others is set at the time of accepting an invite. Attendees could also change the visibility window say from 2 hours around the meeting to 30 minutes around the meeting time. Attendees may also decide not show their locations for any selected meetings. When a meeting invite is rejected or canceled, the location is not shared anymore with other particular meeting attendees.

In accordance with the above-mentioned objects, and those mentioned below, the present invention comprises a method of supplying (and collecting) geographical location data only on need-to-know basis. Unlike other existing location based services and friends' finder systems, the method comprised in the current invention supply (and collect) location data only when there is a need. When the next scheduled meeting is not within the visibility window the system will neither supply nor collect location data. For example, when the next meeting is 10 hours after the current time and the location visibility window is only 2 hours, the system will neither supply nor collect location data for the next 8 hours. This releases the valuable computational resources on the mobile device and also saves lots of battery power. The method also adjusts the frequency of the supply, and corresponding collection, of geographical location data during the visibility window. For example the method could supply (and collect) location data every 15 minutes before 1 hour to the meeting time and the increase the supply (and collection) frequency to every 5 minutes until the meeting time. This again save battery power and releases the mobile device's resources.

In accordance with the above-mentioned objects, and those mentioned below, the present invention comprises a method for filtering details of location data before sharing with meeting attendees. For example the method may give street level location data to a set of attendees while it may give only city level location information to other attendees.

In accordance with the above-mentioned objects, and those mentioned below, the present invention comprises a method for displaying meeting attendees' information both in a geographical map as well as in a non-graphical mode. The attendees' information includes but not limited to location, date, time, picture and shared text. By showing the current status of the meeting attendees, the method helps people avoid calling other attendees just to know their status, there by avoiding the risk of attending a call while driving or so. While showing the location of other attendees the method also displays the expected arrival time, traffic conditions and weather forecasts, giving a good idea about any possible delays to people arriving for a meeting.

In accordance with the above-mentioned objects, and those mentioned below, the present invention comprises a method for communicating with meeting attendees through popular Instant Messaging services, Voice or Video conferencing. The method simplified the selection of people to communicate with respect to a meeting. This method also helps people to broadcast messages to relevant people with respect to meeting reminders.

### 3. The Use of Estimated Time of Arrival (“ETA”) During the Arranging of Meetings on a Communications Network

The present invention contemplates that, during the soliciting, arranging and initiating of meetings by automated messaging upon a communications network, all prospective attendees of any meeting should be informed, and have graphically displayed, both (1) the current geographical position and (2) the estimated time of arrival (“ETA”) at the meeting, of other prospective meeting attendees.

Many benefits flow from this. Prospective attendees may be apprised of the ETA over certain routes based on traffic or other obstructing conditions, and may time their departures accordingly. Should obstructions, or slowing, occur on the way to the meeting, there is no need for a prospective attendee encountering such delays to “guess” his/her updated ETA, but this will be automatically calculated, and available, on the communications device/cell phone of this person and of all other prospective attendees.

Further, other prospective attendees may observe the progress and varying expected ETA's of their fellow prospective attendees, or any of them. It may be observed that some prospective attendees will not likely “make it” on time to the meeting, and what their present expected time of arrival will be. This information may early be recognized by other meeting participants to require a delay in the start of meeting proceedings, and/or a re-ordering of the meeting agenda. Finally, the organizer(s) of the meeting may early and clearly see whether “the meeting is coming together, and timely so”—up to and including the possibility of (1) delaying the meeting via a “flash message” to all prospective attendees, or even (2) canceling the meeting “at the last moment”.

In detail, the situational displays of the present invention are developed by and shown in network communicating devices—preferably cell phones as are preferably (but not necessarily) possessed of Global Positioning System (“GPS”) capability—during the soliciting, arranging and initiating of meetings, potentially between large numbers of attendees and potential attendees as do each have a network communications device. These network communications devices may be, for example, fourth generation programmable cellular telephones, and the communications network may be the cellular telephone network/wireless Internet. The functions to solicit, arrange and initiate meetings are conducted by software processes running within the network communications devices/cellular telephones. Moreover, a substantial portion of the process may be, and preferably is, conducted peer-to-peer, with all network communications devices/cellular telephones communicating between themselves as equals, with none serving as a server nor any other differentiated device. Finally in accordance with the present and related inventions, this software for soliciting, arranging and initiating meetings is quite sophisticated, and capable of rendering to each of a potentially vast number of meeting attendees all current instant information about a scheduled meeting and its prospective attendees.

In the most preferred system any person with a network communications device/cellular telephone can solicit a meeting at a specified time and place with any number of prospective meeting attendees, most normally those persons or groups of persons that are drawn from an electronic address book. Each prospective attendee is automatically messaged, and may optionally vote, possibly in each of a number of “rounds”, as to both (1) alternative meeting time(s), and/or (2) alternative meeting place(s). Even if not actively voting, the network communications device, or cellular telephone, of each prospective attendee is kept aware of all activity transpiring. Indeed, this is how, at the end of negotiations, each person does know when, and where, the meeting is now affirmatively scheduled.

At a predetermined first time interval before a scheduled beginning of the meeting, for example two hours (2 h), begins (1) the interrogating of its then geographical location by the communications device of each prospective meeting attendee, (2) the supplying of this then geographical location to the communication devices of all other prospective meeting attendees, and (3) the presentation of graphical situational displays on the communication devices of all cooperating, communicative, prospective meeting attendees. At this time the ETA of each prospective meeting attendee is calculated, but the time interval (the 2 h) has intentionally been chosen so that all attendees can potentially timely transit to the meeting. If any are already likely late for the meeting—such as may occur if the person has moved directionally away from the meeting, and/or extensive delays have developed on the then-calculated route to the meeting—then these persons are automatically messaged that their optimal time of departure (to make the meeting on time) is already past!

From this time forward any prospective meeting attendee will be alerted at his/her present geographical location and, by calculation of ETA based thereon, when it is deemed necessary and prudent to depart for the meeting. In other words, each prospective attendee is messaged when—in consideration of weather, traffic and other conditions of which the prospective attendee may not even be actively aware—it is prudent to start for the meeting. A safety time factor may be built in to maximize opportunity for timely arrival.

The calculations of ETAs are thus held in abeyance until this predetermined time before the meeting. Being that the geographical position of each prospective attendee is automatically obtained, and automatically distributed to all, it is deemed to be to obtrusive for people to be able to “track” other people all the day long, and many hours in advance of the common meeting, or to judge when others may depart (and perhaps speed illegally on the highways to the meeting). This protection of privacy, as well as the futility and waste of tracking persons by their associated communications devices all the day long for a meeting that is not scheduled to begin for many hours, are the primary reasons to delay geographical position determination and supply from each communications device, and the concomitant calculation of meeting ETAs for each such device.

The interrogating and the displaying of both geographical position and ETA beginning, each attendee may not only see the identities of all other accepting prospective attendees, but may also see the exact present location of each on an initial geographical situational display, and that persons ETA. As well as being of voyeuristic interest, such a display can quickly reveal to all not only the numbers and locations and densities of the prospective meeting attendees, but also whether the meeting at the time and place now scheduled is “logistically expensive”, with large numbers of personnel, and/or important personnel whose time is valuable coming long distances, and/or over time-consuming routes, to the meeting. It can reveal whether a general delay over many paths is in effect as occurs, most normally, due to inclement weather such as a snow or a rain storm.

Clearly persons recognizing that others will be traversing a same or like route to the meeting as they themselves will take are presented information sufficient to support cooperation, and car pooling or the like. Especially if driving between cities, or distant regions, is involved, any two or more people coming to the meeting from, or leaving from the meeting to, a same or nearly same location(s) can be motivated to share transportation, if only to share additional discussion on the subject matter of the meeting. Conversely, it may be seen that the ETAs of other persons are so disparate from ones own ETA that cooperation in transportation is impracticable.

However, the initial geographical situational display and ETAs, tendered to all prospective attendees, is not immediately updated. Instead, this display is preferably not again updated until some predetermined second time interval before the scheduled start of the meeting, normally one hour (1 h) before this scheduled “start time”. Again the ETAs are displayed, and any persons “running late” are so notified if they have not previously been so notified.

Further, as the time to the scheduled meeting draws nigh, the current geographical location and ETA of each meeting attendee is more frequently updated and displayed to all other attendees. At the last the locations of all prospective attendees may be solicited perhaps every five minutes, or even every minute, and the geographical positions and ETAs of each prospective meeting attendee graphically displayed to all attendees, or at least those who, by opening their communication devices/cell phones, do desire to receive this information

Ultimately the progress (or non progress) towards the meeting of each prospective attendee is observable, as well as that attendee's estimate time of arrival, on a graphical display upon the communication device/cell phone of each attendee. Clearly the days of paging, or instant messaging, or calling laggards to the meeting are now become a “thing of the past”, and the machines and software processes now serve to make the evolution of a complex real-world occurrence—a meeting—understandable in real time by use of powerful graphical displays automatically updated.

During this process the communicating of its instant geographical position is optional in the communication device/cell phone of each prospective attendee of the meeting, and may be disabled by the prospective attendee, thereby conserving power at the communications device/cell phone and reducing message traffic upon the communications network. However at least some of the distributed communication devices/cell phones will supply their instant geographical location.

Moreover, a communications device/cell phone may optionally automatically fail to interrogate its then current geographical location (at a predetermined time) (so as to supply this then-current geographical position to the other communication devices/cell phones) if this geographical location is sensed not to have changed from a previously-supplied location, thereby conserving communications power. The geographical position is normally sensed not to have changed by an accelerometer present within the communications device/cell phone.

From the graphically displayed identities and geographical locations of prospective attendees of the meeting each communications device/cell phone can at any time automatically proceed to establish an audio/video/instant messaging conference with the prospective attendees of the meeting. The potentially tedious process of bringing up a conference or communications tool, and/or remembering or entering all the prospective meeting attendees in order to communicate, is not necessary. A single keystroke permits instant communication with any and all (cooperating, online) prospective attendees of the (particular, scheduled) meeting.

Any attendee of the meeting may at any time message a “sticky note” that will appear on the geographical location display of all attendees, wherein when this message says “Go ahead, I will be late by 30 minutes” or like explanatory information, then all other prospective attendees of the meeting may act accordingly. Notably the person generating such a message may increasingly timely do so because he/she is apprised of his/he instant ETA.

### 4. Graphical Displays of Geographical Locations and ETAs in a Networked Method of Soliciting and Arranging and Initiating a Meeting

Accordingly, in one of its aspects the present invention is embodied in a method performed on and between communicating devices distributed upon a communications network for the purpose(s) of soliciting and arranging and initiating a meeting.

The method includes (1) supplying from the communication device of each prospective attendee of a meeting its instant geographical location to a central computer; (2) calculating at the central computer from the received instant geographical location of the communication device of each prospective attendee supply this information the expected time of arrival of the prospective attendee at the meeting; (3) sending from the central computer to an enabled communication devices of each and all prospective attendees of the meeting the then estimated times of arrival at the meeting of each and all prospective attendees; and (4) displaying on the enabled communication devices of each and all prospective attendees of the meeting the then estimated times of arrival at the meeting of each and all prospective attendees.

The method calculating of the estimated time of arrival is preferably further in respect of at least one of the factors of weather, traffic flow rate, traffic roadblocks and stoppages, the traffic route being followed to the meeting location, and the actual rate of progress along the route to the meeting location.

The method sending is preferably further of the then geographical location of each prospective attendee of the meeting; and the displaying is further graphically of the then geographical location of each prospective attendee of the meeting.

Preferably the supplying and the calculating and the sending and the displaying are held in abeyance until a predetermined first time interval before the meeting. Then, after this predetermined first time interval before the meeting, the calculating indicates any prospective attendee of the meeting is already late for the meeting, so notifying that attendee.

Also, after this predetermined first time interval before the meeting, each prospective attendee of the meeting is notified as to last time to depart to timely make the start of the meeting.

In the method the supplying is normally enabled by interrogating instant geographical location from the Global Positioning System. However, the instant geographical location can also be determined by triangulation to the communications towers of the cellular tepehony system.

From the graphically displayed identities and geographical locations and ETAs of prospective attendees of the meeting, each communications device can at any time automatically proceed to establish an audio/video/instant messaging conference with the prospective attendees of the meeting.

Any prospective attendee of the meeting may at any time message a “sticky note” that will appear on the display of all attendees. Such a message can say, for example, “Go ahead, I will be late by 30 minutes” or like explanatory information, permitting all other prospective attendees of the meeting may act accordingly.

These and other aspects and attributes of the present invention will become increasingly clear upon reference to the following drawings and associated specification.

### BRIEF DESCRIPTION OF THE DRAWINGS

The preferred embodiments of the invention will hereinafter be described in conjunction with the appended drawings, provided to illustrate and not to limit the invention, wherein like designations denote like elements, and in which:

FIG. 1 is a block diagram illustrates a simplified representation of the infrastructure where the various methods of the current invention can be practiced.

FIG. 2 is an illustration of the various modules that play direct impact on arriving at a scheduled meeting location.

FIG. 3 shows various system modules involved with the operation of the invention.

FIG. 4 is a general flow of the various steps taken during the process of controlled location sharing by the system and the mobile users.

FIG. 5 is a flow diagram illustrating a method of accepting meeting invites based on non-conflict meeting venues and meeting times.

FIG. 6 is a further flow diagram illustrating a method for accepting meeting invites based on non-conflict meeting venues and meeting times.

FIG. 7 is a pictorial representation of a scenario where a scheduled meeting is shown on a geographical map

FIG. 8 is another pictorial representation of the scenario of FIG. 7 where the new locations of the meeting attendees are shown after 30 minutes.

FIG. 9 is another pictorial representation of a scenario where a new location 910 is recommended by the system based on current ETA of the meeting attendees.

FIG. 10 is a flow diagram that illustrates a method of collecting location data from users' mobile devices only on need-to-know basis

FIG. 11 is a general message flow among Instant Message users while setting an on-the-fly meeting

FIG. 12 is a flow diagram illustrating the method of sharing location data only among meeting attendees as preferred by the users

FIG. 13 is block diagram of various modules involved in on-the-fly meeting scheduler using SMS and Instant Messaging

FIG. 14 is an environment where on-the-fly meeting scheduling and location sharing are practiced.

FIG. 15 is a flow chart showing the avoidance of the colleting of positional data when it is sensed by a network communication device that its position has not changed.

FIG. 16 is a sample screen shot of a meeting status display in accordance with the present invention.

### DESCRIPTION OF PREFERRED EMBODIMENT

The present invention provides a method and system for sharing physical locations in a controlled environment, on need-to-know basis. The present invention also provides a method and system that increases the productivity of meeting attendees by sharing the expected arrival times and the real time physical locations of meeting attendees. The present invention also provides a method and system that shares the physical locations of only the people of interest and their arrival time. The present invention also provides a method and system to alert people based on geographical locations of meeting attendees and changing environments like traffic congestions, weather and travel delays. The present invention also provides a method and system that simplified the selection of only relevant people to communicate.

The present invention also provides a method of synchronizing users' native calendars and a centralized data management system. Further any accept or reject action taken on any meeting invites are also synchronized along with the optional shared location details. The present invention also provides a method where the physical locations of meeting attendees are collected periodically and presented in a controlled manner to only authorized people. The present invention also provides a method to select only people of interest and communicate with them. The present invention also provides a method that shows a simplified real time traffic conditions, expected time of arrival and any potential travel delays including ones caused by weather conditions.

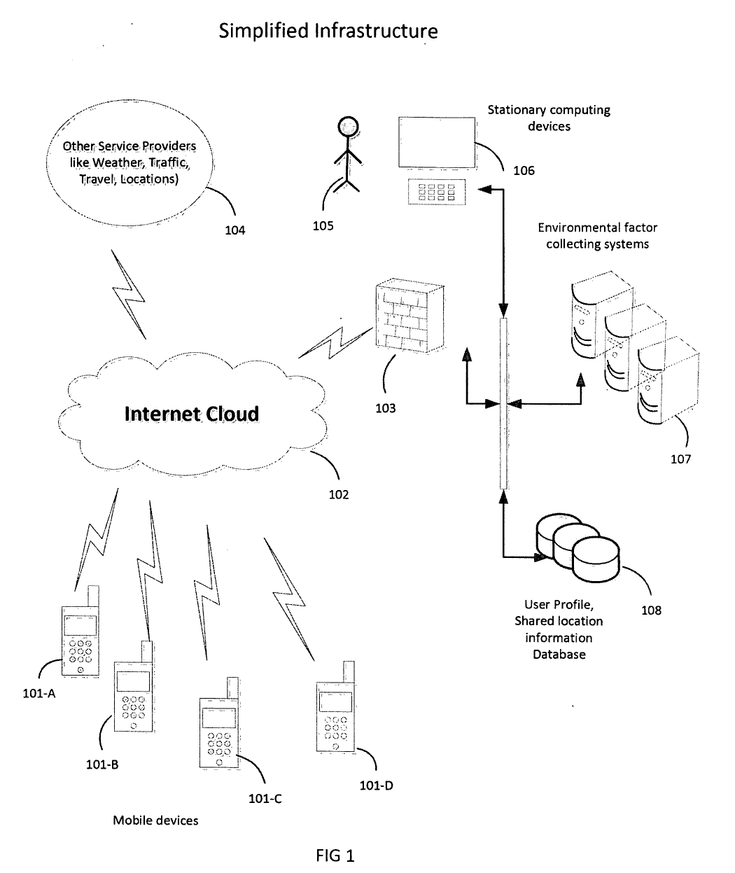

FIG. 1 illustrates a simplified representation of the infrastructure where the various methods of the current invention can be practiced. Users of the current invention include mobile users with mobile devices 101-A, 101-B, 101-C and 101-D and others 105 with non-mobile platforms 106 share their physical locations in a controlled environment. Meetings organized through native calendaring systems or customized application by one or more of the users and invites are sent across the internet cloud 102. Users act on meeting invites (accept, reject) and also set from when their location can be exposed to other same meeting attendees. Respective users' mobile devices based on the accepted meeting start time, start collecting current location data; they also collect Weather, Traffic and Travel plans from service providers 104. The environmental factor collecting system 107 then applies business and personal settings as stored in database 108 helps the device to arrive at an estimated time of arrival for a meeting. In the absence of services from other components 104, 107 and 108, the mobile devices themselves estimate the arrival time from current location to the next immediate meeting location and alerts when the estimated arrival time passes the next meeting's start time.

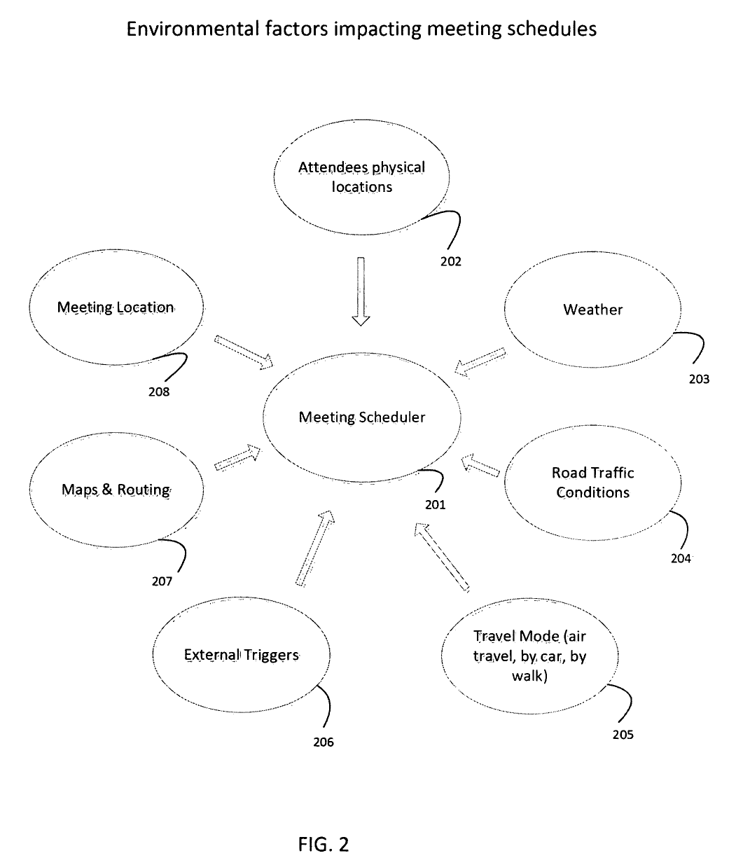

FIG. 2 is illustrates the various modules that play direct impact on arriving at a scheduled meeting location. The meeting scheduler 201 periodically collects the meeting attendees' physical location 202, weather forecast 203 for both the meeting location and the current location, traffic conditions 204 along the route from current location to the meeting venue, any travel itinerary data 205 and calculates the best route using the map and route modules 207 to reach the meeting location 208. Optionally external triggering points 206, like road constructions, delay in flights, etc. are also considered while estimating the route calculation and estimated arrival time from user's current location to meeting place.

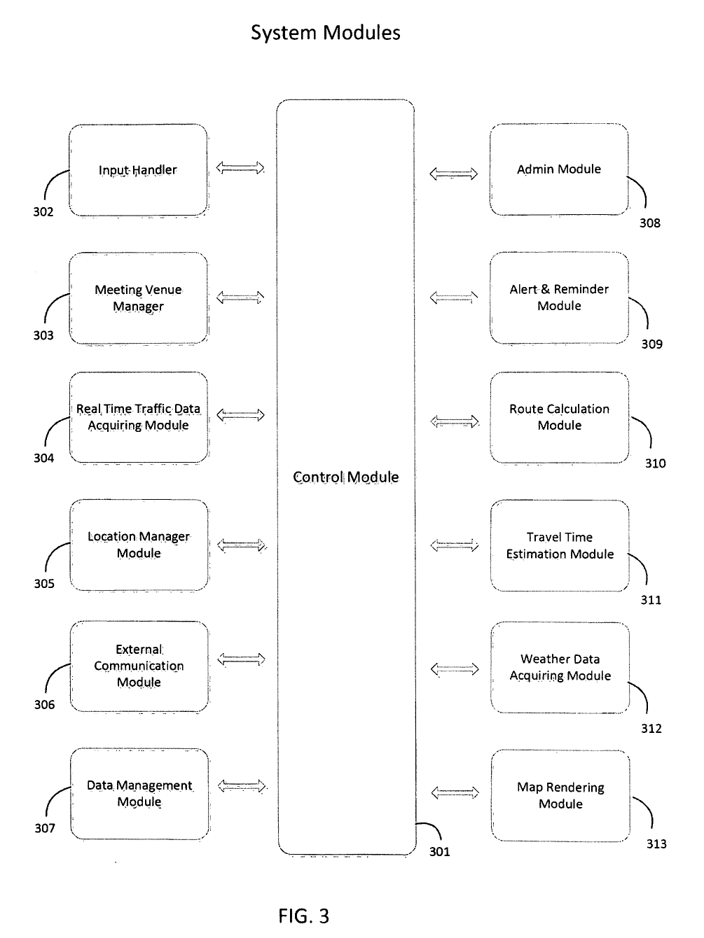

FIG. 3 shows various system modules involved with the operation of the invention. The main Control Module 301 manages the message flows, state transitions and security of the messages. Input Handler 302 process location requests from other mobile devices, update in location information for mobile devices, request for meeting details, meeting and networking invites from users. Meeting Venue Manager 303 manages previously used meeting locations, users' preferred meeting locations and suggesting meeting locations based on current physical locations of meeting attendees. The Real-time Traffic Data Acquiring Module 304 periodically collects traffic data, filters out unwanted information based on scheduled meetings and locations of meeting attendees. Location Manager Module 305 manages and applies various business and personal setting rules and provide or not provide relevant location details of the users. External Communication Module 306 manages all access in and out of the system with any 3rd party service providers including weather, traffic, travel plans, etc. Data Management Module 307 stores and retrieves collected data in a data storage medium, either on a database, text files or on system memory. The Admin Module 308 manages all user accounts, authentications, service validations and system operations. The Alert & Reminder Module 309 based on the setting generates reminders and choose the right media to send the alert to mobile users. Travel Time Estimation Module 311 uses calculated routes by 310, weather data collected by Weather Data Acquiring Module 312, Realtime Traffic Data Acquiring Module 304 to estimate the arrival time for users from their current locations to the meeting place. It further uses the Map Rendering Module 313 and creates the right map data with all meeting attendees' location, estimated time of arrival and travel route highlighted.

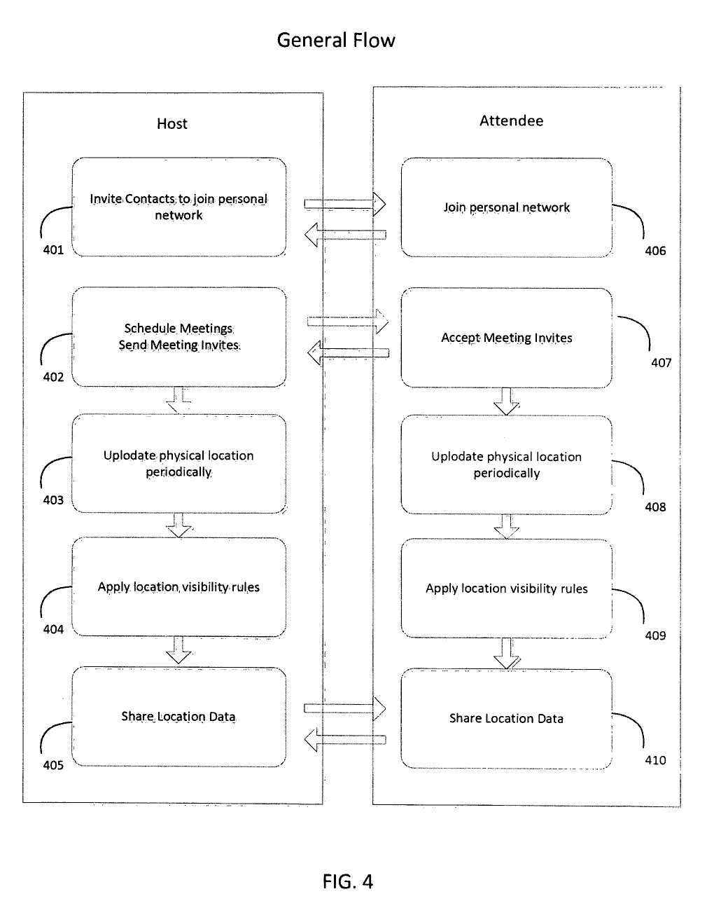

FIG. 4 is a general flow of the various steps taken during the process of controlled location sharing by the system and the mobile users. Typically users gets connected to a network by inviting other to join the network 401. This is to avoid reentering user profiles, preferences and contact details, etc. every time they need to communicated with other users. The other parties take actions 406 on the network invitation with by accepting or rejecting to join the network. Once accepted anyone can be a host and schedule meetings and invite others to join the meeting 402. Meeting invites could again be accepted or rejected by other invitees 407. Invitees while accepting to join a meeting set from when exactly their location data shall be collected and shared with other meeting attendees. Based on their preference all attendees upload their physical locations periodically 403, 408 to the server. When time comes to share the location data and requested by meeting invitees system applies appropriate business and personal settings and filters out relevant data 404, 409. The filtered data is shared among meeting attendees prior and during the meeting time 405, 410.

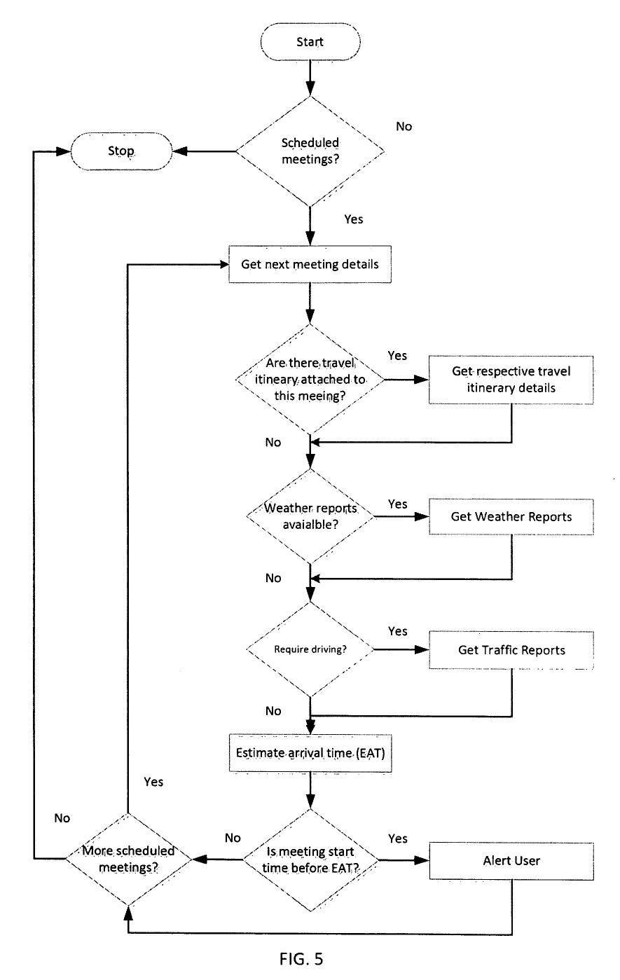

FIG. 5 is a flow diagram illustrating a method of alerting users on meetings based on current physical locations. From the scheduled meetings 502, details of the meetings 503 are collected. If there is any travel involved respective itinerary 504 is collected 505. For both the destination and meeting venue, the weather report is obtained 507 if one available 506. If reaching the meeting location required driving from one place to another 508 respective realtime traffic data is also collected 509. An Estimated Arrival Time is calculated 510 based on the above collected data and checked against the next immediate meeting's start time 511. An alert is generated 512 if arrival time over shoots the meeting start time. The logic runs on other scheduled meetings 513 also.

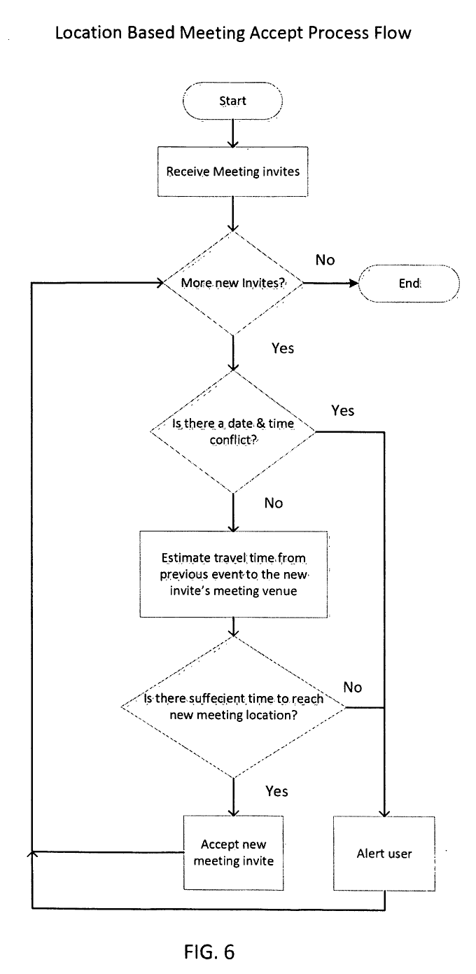

FIG. 6 is another flow diagram where other scheduled meeting locations and current location of the invitee are checked and estimation on travel time is calculated to help accept or reject invites. On receiving a meeting invite 602 date and time conflicts are checked with already planned meetings 605 and if there was no conflict the travel time is estimated from the location of the meeting that's prior to this current invite to the meeting location of the current invite. Only when there is enough time to reach from previous meeting to the new meeting location 607 invite is accepted 608 otherwise user is alerted 609.

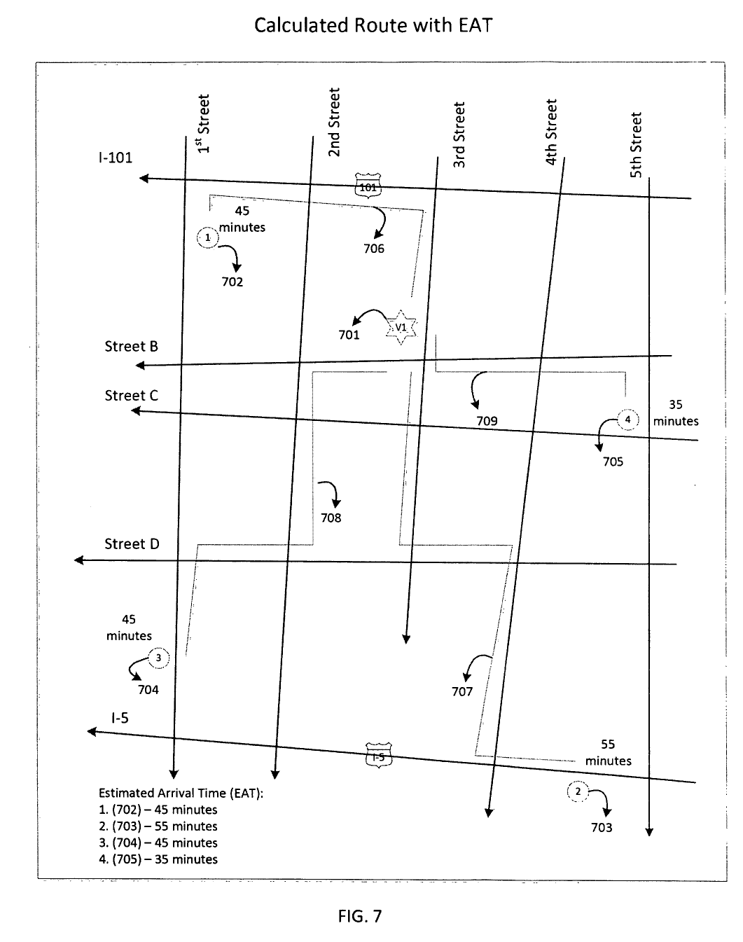

FIG. 7 is a pictorial representation of one scenario where a scheduled meeting is shown on a geographical map with meeting location 701 meeting attendees 702, 703, 704 and 705 along with the initial estimated arrival time, respective travel route 706, 707, 708 and 709.

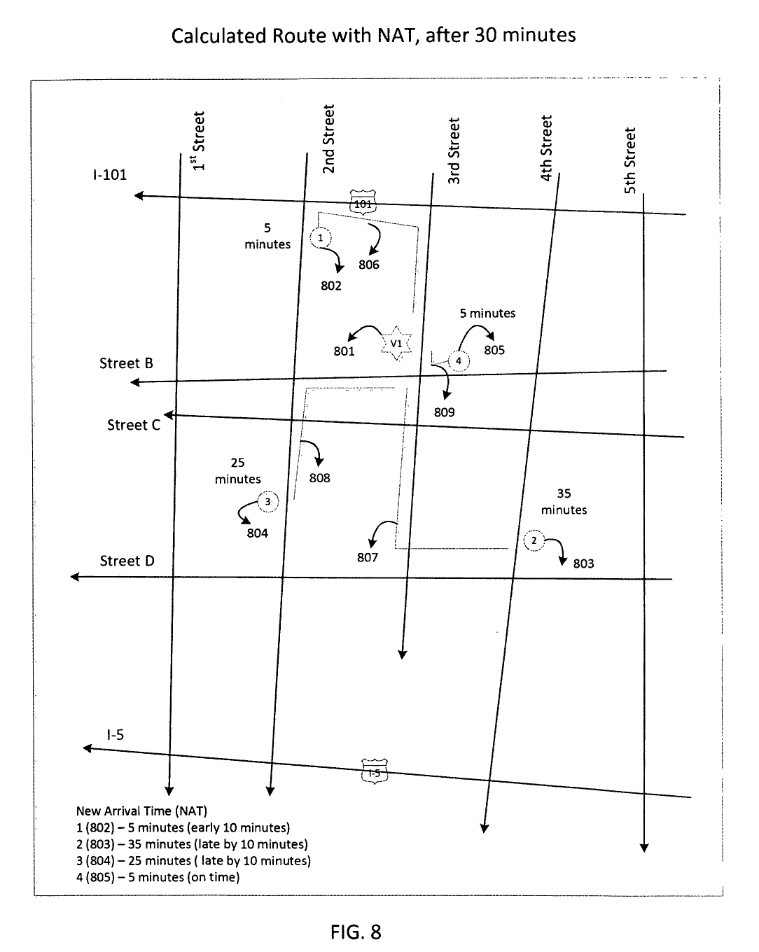

FIG. 8 is another pictorial representation of one of the scenario after 30 minutes, where the new locations of the meeting attendees 802, 803, 804 and 805, their new estimated arrival times and the current routes 806, 807, 808 and 809 are shown on a geographical map. According to this representation attendee 802 would reach early to the meeting location 801, attendee 803 and attendee 804 will be late by 10 minutes and attendee 805 would be on time; which means attendee 802 will be waiting for 20 minutes and attendee 805 will be waiting for 10 minutes for attendee 803 and 804 to arrive.

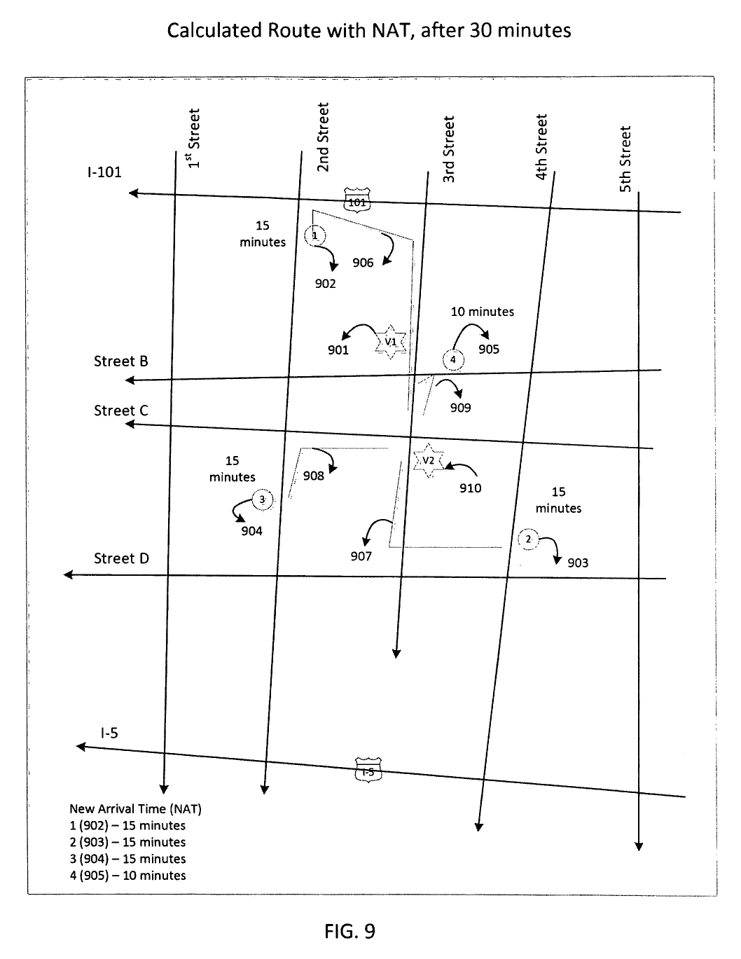

FIG. 9 is another pictorial representation of one of the scenario where a new location 910 is recommended by the system so that all attendees would meet around the same time. According to this illustration only attendee 905 would have to wait for 5 minutes for other to turn in.

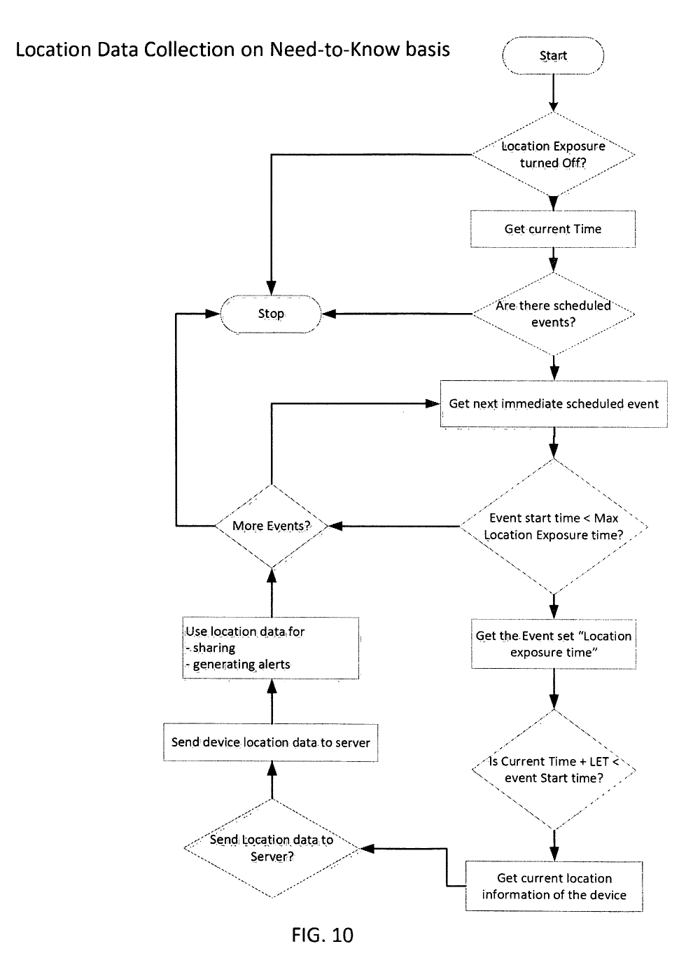

FIG. 10 is a flow diagram that illustrates a method of collecting location data from users' mobile devices only on need-to-know basis. Only when there were location sharing enabled event 1004 the system estimate the data collection start time based on meeting start time and Location Exposure Time 1006, 1007. If current time is later than the location data collection start time 1008 the current location of the device is collected 1009. This data is then sent 1010 to the server to share with other meeting attendees. The same location data is also used to generate location based alerts 1012.

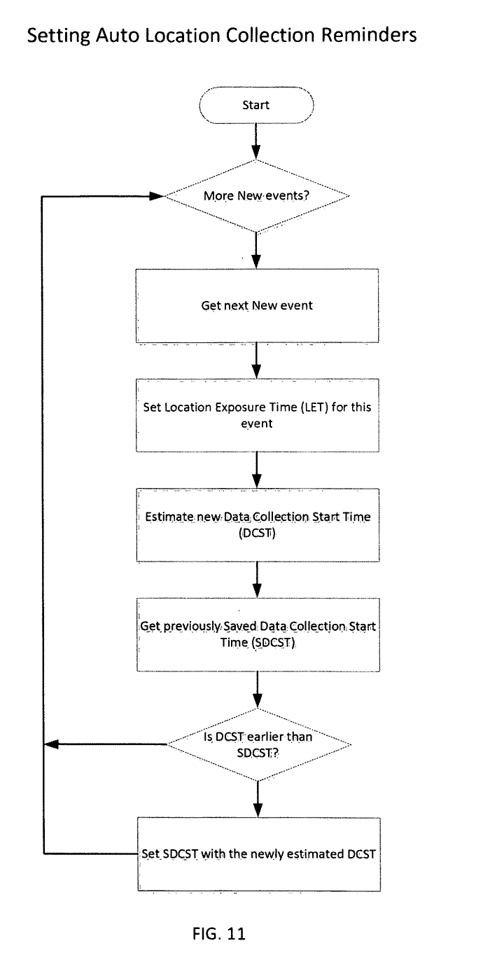

FIG. 11 is a general message flow among Instant Message users while setting a on-the-fly meeting. A on-the-fly meeting invite is generated through chat or SMS among a set of contacts. Along with the invite a unique key 1502 and optionally a link to a shared location information is sent. The Control Module 1504 is also informed about the meeting and the unique key. The Control Module 1504 waits for attendee 1503 to accept the invite and identify with the unique key 1502 as distributed by 1501. Control Module accepts periodic location updates by 1501 and 1503 and in turn returns the information on last reported location data from 1501 and 1503. This completely by passes the calendaring systems and purely works on SMS and IM messages while providing the complete privacy between the users.

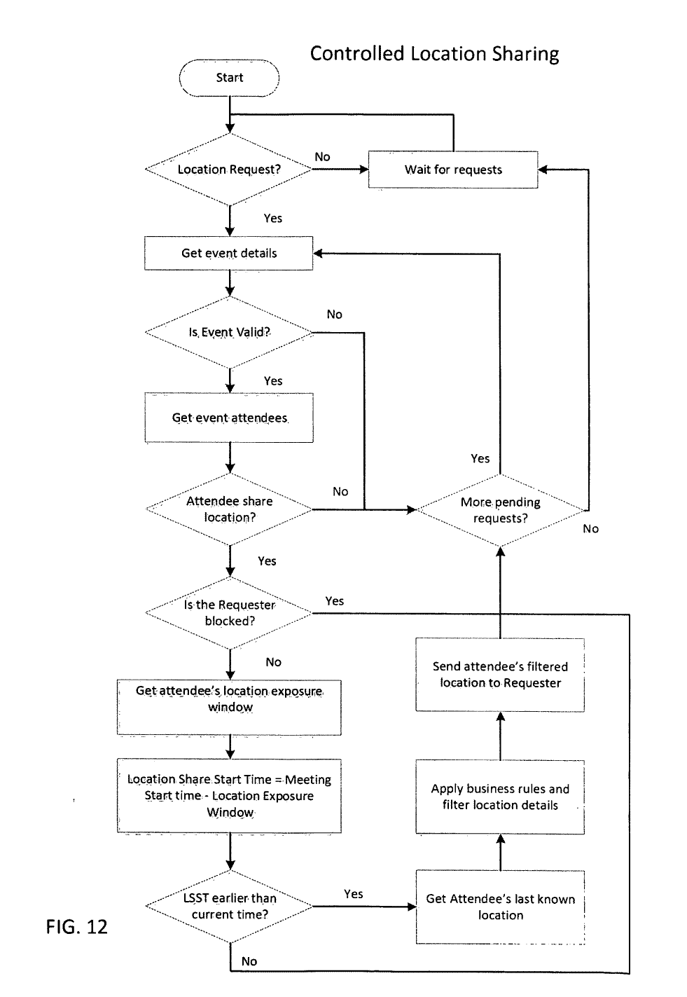

FIG. 12 is a flow diagram illustrating the method of sharing location data only among meeting attendees as preferred by the user. Only when the location requester was a host or one of the meeting attendee 1201 location will be shared. Only when the mobile user willing to share his/her location with the requester 1203 location data will be shared. Further based on the meeting start time and the exposure window set by the user 1205 and only when the Location Share Start Time is earlier than the current time 1206 attendee's last reported location is obtained 1207. Further business rules and personal setting applied on the collected location data to filter out Street level 1211, City level 1212 or State level 1213 for sharing with the requester.

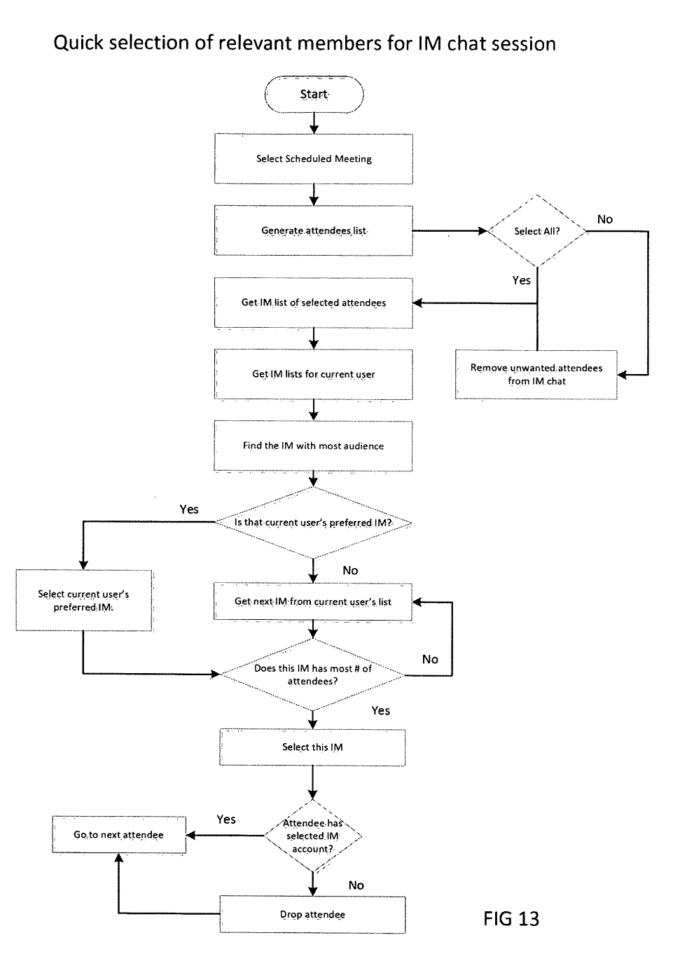

FIG. 13 is block diagram of various modules involved in on-the-fly meeting scheduler using SMS and Instant Messaging. A random key-pair generator module 1301 generates a unique key-pair for each on-the-fly meetings. The public key is distributed to other meeting invitees while the private key is kept by the Control Module 1308. IM users update their location data 1302 encrypted with the public key which is unique to that meeting along with their identification, which could be their Messenger ID for example. The Location Data Decrypt Module 1304 decrypts the data using the private key. Only when the sender ID matchers with one of the meeting attendee the location data is updated in the shared link, which is managed by the Shared Link Manager 1307. The Instant Messenger Interface 1306 handles all messages to and from Instant Messenger. The Map Engine 1305 puts together all the location data collected from the attendees on to a suitable geographical map and place that under the link identified with the unique private key. The Communication Module 1303 takes care of user authentication, data transportation from and to the Control Module 1308 and to all the shared location links.

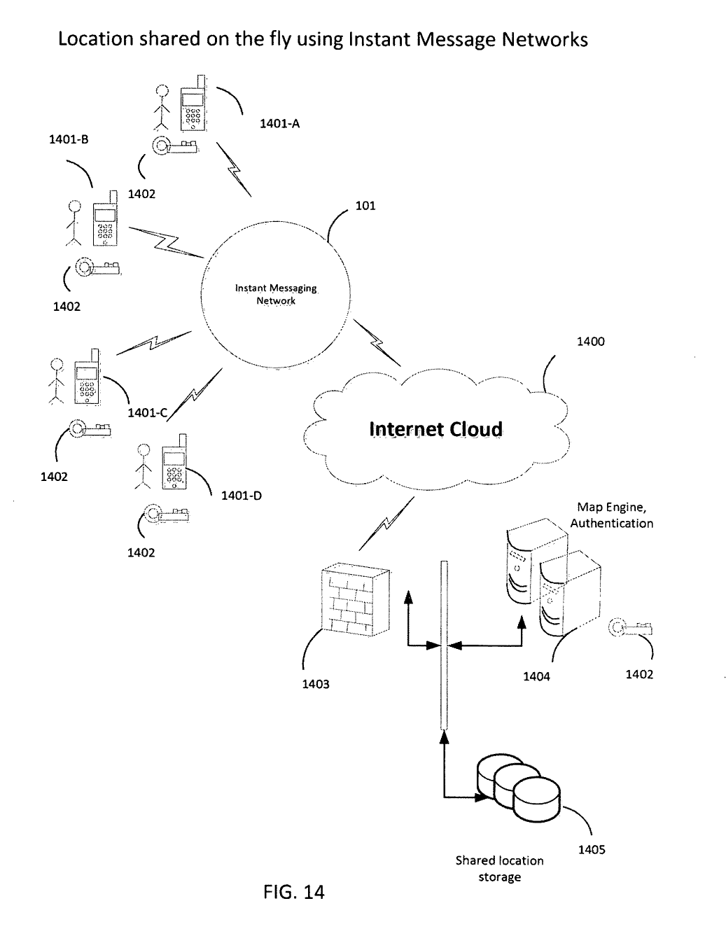

FIG. 14 is an environment where all on-the-fly meeting scheduling, location sharing practiced. Users 1401-A, 1401-B, 1401-C and 1401.D after joining the Instant Messenger 1401, communicate and schedule a meeting on-the-fly. The Messenger gets unique public key and a link to send the location data from the system through internet 1400. Location data encrypted with the public key are decrypted at the server by the Map and Authentication system and stored in the shared location area 1405.

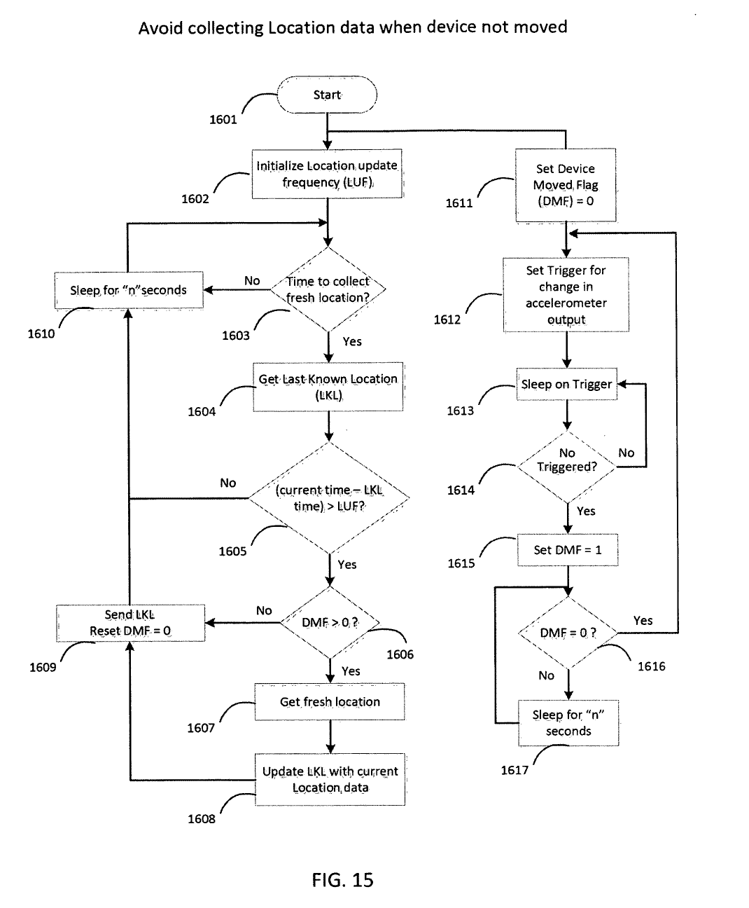

FIG. 15 is a flow chart showing the avoidance of the colleting of positional data when it is sensed by a network communication device that its position has not changed, making that to expend the energy necessary to (again) find the instant geographical position would be unproductive, unnecessary and irrelevant. Thus the flow diagram of FIG. 15 illustrates the logic used to preserve battery power and CPU power of the mobile device by avoiding the fresh location data collection, when the device found not physically moved since the last time device location was obtained. The Location Update Frequency (LUF) in number of seconds is set at 1602. The system periodically checks the time to collect fresh location data 1603 and if the condition met, it retrieves 1604 the Last Known Location (LKL) from previously stored place. If the time difference between the current time and the LKL time is greater than the LUF 1605 the Device Moved Flag (DMF) values is checked. The DMF which is set by another thread 1615. If DMF found set, the device acquire fresh location data, from GPS or from cellular infrastructure or from other means 1607 and sends to the requester 1609. In the same FIG. 15 the flow to set a trigger 1612 to a sleeping program 1613 when any change in accelerometer is found. The triggered program sets DMF and goes to sleep again for the DMF to be reset 1617.

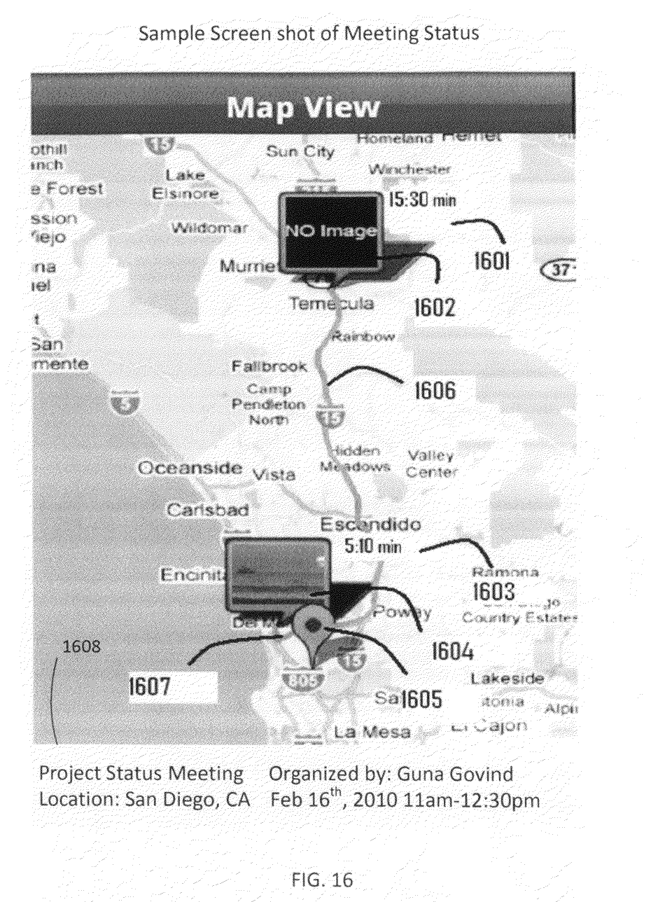

FIG. 16 is a sample screen shot of the meeting status as displayed in the present invention. The scheduled meeting 1605 and the meeting attendees 1604, 1602 are shown just before the meeting on a graphical map display. Information of the meeting is shown at the bottom 1608 that describes the headline of the meeting, Organizer of the meeting, Location, scheduled date, start and end time for the meeting. The ETA 1601 for attendee 1602 and the ETA 1603 for meeting attendee 1604 are also displayed 1601 in the information rich meeting reminder. The possible route 1606 that attendee 1602 would take and the route 1607 that attendee 1604 would take to arrive at the meeting is also illustrated in the same screen.

According to these variations, and still others within the skill of a practitioner of the porous metal, ceramic and carbon, arts, the present invention should be considered in accordance with the following claims, only, and not solely on accordance with those embodiments within which the invention has been taught

What is claimed is:

1. A method performed on and between communicating devices distributed upon a communications network for the purpose(s) of soliciting and arranging and initiating a meeting, the method comprising:
supplying from the communication device of each prospective attendee of a meeting its instant geographical location to a central computer;
calculating at the central computer from the received instant geographical location of the communication device of each prospective attendee supply this information the expected time of arrival of the prospective attendee at the meeting;
sending from the central computer to an enabled communication devices of each and all prospective attendees of the meeting the then estimated times of arrival at the meeting of each and all prospective attendees; and
displaying on the enabled communication devices of each and all prospective attendees of the meeting the then estimated times of arrival at the meeting of each and all prospective attendees.

2. The method according to claim 1 wherein the calculating of the estimated time of arrival is further in respect of at least one of the factors of
weather,
traffic flow rate,
traffic roadblocks and stoppages;
traffic route being followed to the meeting location, and
rate of progress along the route to the meeting location.

3. The method according to claim 1
wherein the sending is further of the then geographical location of each prospective attendee of the meeting; and
wherein the displaying is further graphically of the then geographical location of each prospective attendee of the meeting.

4. The method according to claim
wherein the supplying and the calculating and the sending and the displaying are held in abeyance until a predetermined first time interval before the meeting.

5. The method according to claim 4
wherein, after this predetermined first time interval before the meeting, the calculating indicates any prospective attendee of the meeting is already late for the meeting, so notifying that attendee.

6. The method according to claim 4
wherein, after this predetermined first time interval before the meeting, each prospective attendee of the meeting is notified as to last time to depart to timely make the start of the meeting.

7. The method according to claim 1 that, before the supplying, further comprises:
interrogating instant geographical location from the Global Positioning System;
wherein the supplying is of instant geographical location as is determined by the Global Positioning System.

8. The method according to claim 3
wherein, from the graphically displayed identities and geographical locations and ETAs of prospective attendees of the meeting, each communications device can at any time automatically proceed to establish an audio/video/instant messaging conference with the prospective attendees of the meeting.

9. The method according to claim 1
wherein any prospective attendee of the meeting may at any time message a “sticky note” that will appear on the display of all attendees;
wherein when this message says “Go ahead, I will be late by 30 minutes” or like explanatory information, then all other prospective attendees of the meeting may act accordingly.

10. On and between communicating devices distributed upon a communications network, a method for soliciting and arranging and initiating a meeting, the method comprising;
initiating from a one device (1) a solicitation for meeting (3) at a specific time (3) at a specific place (4) to a then specifically enumerated group of other devices as are each then possessed by an associated human who is a potential attendee of the meeting;
each of the solicited devices of the group either (A) standing mute, (B) declining attendance of the associated human, or (C) accepting attendance by the associated human, to all others of the solicited devices of the group so that, ultimately, all devices of humans indicating acceptance do also know which other humans are intending to attend the meeting;
each of the solicited devices of the group automatically accepting at any time thereafter the initiating up to the time of meeting either (A) no response then-solicited from a member of the group, or, equivalently, (B) a negative response from a particular device of the group, as a disavowal that the associated human should thereafter attend the meeting, and communicating no more regarding the meeting with that particular device;
forebearing that a disavowal of intent to attend be caused by an associated human to eruptively be sent, automatically reconfirming with each device said intent of the associated human to attend the meeting as well as providing the then geographical location of the device and associated human to all of the solicited devices then still indicating intent to attend, whereupon all may know a most current roster of remaining devices/persons still expecting to attend, but also the then geographical locations of these then-expected devices/attendees.

11. The method according to claim 10 further comprising:
affording each human potential attendee receiving the meeting request an opportunity to accept or reject with his/her associated device the meeting request, communicating this acceptance/rejection of the meeting request to all devices of the group so that a resulting roster of prospective meeting attendees is seen by all; and
as the scheduled time of the meeting draws nigh, having the devices of at least a plurality of prospective meeting attendees both (1) communicate via his/her associated device his/her own geographical whereabouts to the devices of at least the then-communicating plurality of all other the prospective meeting attendees, while then (2) displaying at the associated devices of at least the then-communicating plurality of the prospective meeting attendees the then instant geographical locations of all others of the then-communicating prospective meeting attendees.

12. The method according to claim 10
wherein the (4) specifically enumerated group of other devices to which the meeting request is communicated are selectable by the human originating the meeting request, different groups of selected attendees being possible for different meetings.

13. The method according to claim 10 wherein, between the initiating and the affording, a device then (A) possessed by a human who is a potential attendees of the meeting is (B) selectively controllably enabled to receive the meeting request by the human possessor thereof, making that the human possessor of a device may disable his/her device from receipt of the meeting request.

14. The method according to claim 13 wherein
the device then (A) possessed by the human who is a potential attendee of the meeting is (B) selectively controllably enabled to receive a meeting request depending upon the identity of the originator of the meeting request, being receptive to meeting(s) request(s) from some of the multiplicity of devices and associated humans, and not from others of the devices and associated humans.

15. The method according to claim 10 wherein
as the scheduled time of the meeting draws nigh, the devices of each and all prospective meeting attendees both (1) communicate via his/her associated device his/her own instant geographical whereabouts to the devices of all other the prospective meeting attendees, and (2) graphically display the then instant geographical locations of all others of the prospective meeting attendees.

16. The method according to claim 10 wherein, between the initiating and the affording, a device then (A) possessed by a human who is a potential attendee of the meeting is (B) selectively controllably enabled to communicate its geographical location.

17. The method according to claim 16 wherein the device of the potential attendee of the meeting is so selectively controlled to communicate its geographical location based on the temporal proximity of the meeting, communicating where it is spatially when the meeting draws nigh, but not before.

18. The method according to claim 10 further comprising:
as travel of a device communicating its geographical whereabouts to all other devices if effectuated, calculating an estimated time of arrival at the meeting destination, and additionally communicating this estimate;
wherein the time of arrival of meeting attendees, including those running late, can be seen upon the devices of all attendees.

19. The method according to claim 18 wherein the calculating of the estimated time of arrival is in respect of at least one of the factors of
weather,
traffic flow rate,
traffic roadblocks and stoppages;
traffic route being followed to the meeting location, and
rate of progress along the route to the meeting location.

20. The method according to claim 10 that, between the initiating and the affording, further comprises:
communicating human input at one device regarding proposed changes in any of meeting time, place and attendees to all other devices;
permitting voting by the human at each device amongst alternatives then offered for meeting time and place and attendees; and
automatically calculating a most preferred meeting time and place identically at each device, whereupon confirmation/acceptance/intent-to-attend, or else disavowal/intended non-attendance, as a human may choose his/her personal case to be, is communicated to all.

21. The method according to claim 10 adopted and directed to organizing ad hoc a meeting in the present and centered about the spatial location of a meeting initiator wherein
the initiating of the request for meeting is predicated on, not only, the then specifically enumerated group of other devices as are then possessed by humans who are potential attendees of the meeting, but, also, such of these potential attendees as are then instantly spatially proximate, and to the extent of this instant spatial proximity, presumptively receptive to a request to meet instantly then and there, being that it is presumptively convenient to all to do so;
wherein the method so conducted facilitates serendipitous meeting, causing the alerting of devices and associated persons who are, at any one instant of time, spatially and temporally proximate to each other.
